(19) United States
(12) Patent Application Publication
(10) Pub. No.: US 2015/0278842 A1
(43) Pub. Date: Oct. 1, 2015

(54) SYSTEM, DEVICE, AND METHOD FOR ECOMMERCE GAMING

(71) Applicant: Talla Thiam, Oklahoma City, OK (US)

(72) Inventor: Talla Thiam, Oklahoma City, OK (US)

(21) Appl. No.: 14/666,885

(22) Filed: Mar. 24, 2015

Related U.S. Application Data
(60) Provisional application No. 61/970,739, filed on Mar. 26, 2014.

(51) Int. Cl. G06Q 30/02

(52) U.S. Cl. CPC G06Q 30/0209

(57) ABSTRACT

A system for ecommerce and gaming includes an online sales system and an ecommerce gaming application, such that a customer can play a game on the ecommerce gaming application, and thereby earn shopping discounts, which can be used to purchase products at a reduced price on the online sales system. An ecommerce gaming application can include a processor, a memory, an input/output, a game controller, a discount manager, and a purchasing manager. A method for earning shopping discounts during gaming includes the acts of playing a game, updating a discount level, and purchasing products.

### CROSS REFERENCE TO RELATED APPLICATIONS

This application claims the priority of Provisional Application No. 61/970,739 filed on Mar. 26, 2014, inventor Talla Thiam, entitled “System, device, and method for ecommerce gaming.” The entire disclosure of this provisional patent application is hereby incorporated by reference thereto, in its entirety.

### FIELD OF THE INVENTION

The present invention relates generally to the field of shopping and gaming, and more particularly to novel systems and methods for earning shopping discounts during game play.

### BACKGROUND OF THE INVENTION

Online shopping, also referred to as ecommerce has been in rapid growth during the past decade. Similarly, online games have become a popular pastime for millions of users worldwide.

However, until now there have been only limited attempts at combining these two major areas of online user activity, and particularly there are no gaming products which incentivize shopping based on gameplay performance.

As such, considering the foregoing, it may be appreciated that there continues to be a need for novel and improved devices and methods for combining online shopping with online gaming.

### SUMMARY OF THE INVENTION

The foregoing needs are met, to a great extent, by the present invention, wherein in aspects of this invention, enhancements are provided to the existing model of shopping, to include shopping discounts that are earned by winning games or achieving certain game play levels.

In an aspect, a system for ecommerce and gaming includes:
a) An online sales system; and
b) An ecommerce gaming application;
such that a customer can play a game on the ecommerce gaming application, and thereby earn shopping discounts, by winning games or reaching game levels, so that the customer can use the earned shopping discounts to buy discounted products in the online sales system.

In related aspects, the customer can use the earned discounts directly in the online sales system, or alternatively the customer can complete discounted purchase transactions via the ecommerce gaming application.

In related aspects, the online sales system can be a website, a mobile app, a desktop application, a server, or some other computer system.

In related aspects, the ecommerce gaming application can be a website, a mobile app, a desktop application, an embedded application, or some other computer application.

There has thus been outlined, rather broadly, certain embodiments of the invention in order that the detailed description thereof herein may be better understood, and in order that the present contribution to the art may be better appreciated. There are additional details and embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Other objects and advantages of the present invention will be more readily apparent from the following detailed description when read in conjunction with the accompanying drawings.

### BRIEF DESCRIPTION OF THE DRAWINGS

FIG. 1 is a schematic diagram illustrating a system for ecommerce gaming, according to an embodiment of the invention.

FIG. 2 is a schematic diagram illustrating an ecommerce gaming application, according to an embodiment of the invention.

FIG. 3 is a flowchart illustrating a method for earning shopping discounts during gaming, according to an embodiment of the invention.

### DETAILED DESCRIPTION OF THE INVENTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

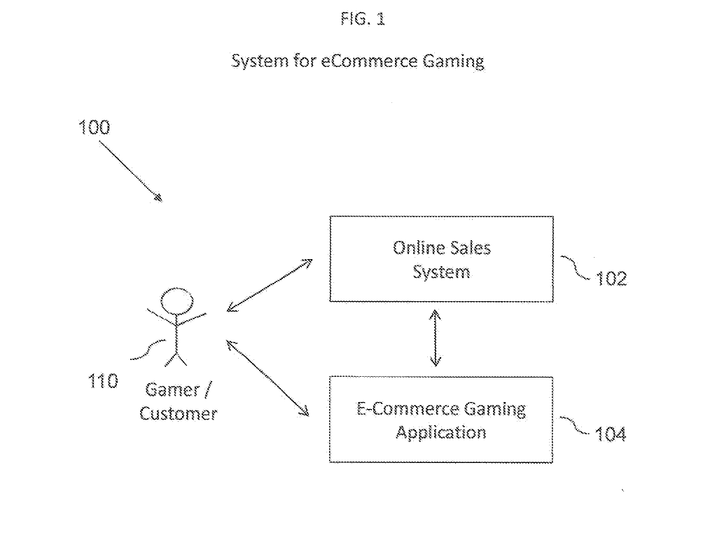

In the following we describe the structure of a preferred embodiment of a system for ecommerce and gaming 100 with reference to FIG. 1, in such manner that like reference numerals refer to like components throughout; a convention that we shall employ for the remainder of this specification.

In the preferred embodiment, a system for ecommerce and gaming 100 includes:
An online sales system 102; and
An ecommerce gaming application 104;
   Wherein a customer 110 can play a game on the ecommerce gaming application 104, and thereby earn shopping discounts, such that the customer 110 can complete a product purchase transaction on the online sales system.

In a related embodiment, the product purchase transaction can be executed by the customer 110 in direct communication with the online sales system 102, for example using a discount code issued by the ecommerce gaming application 104 or by use of a single-sign-on user id, wherein the discount level can be looked up by the online sales system 102 in communication with the ecommerce gaming application 104.

In related embodiments, the online sales system 102 can be a website, a mobile app, a desktop application, a server, or some other computer system.

In a related embodiment, the product purchase transaction can be executed by the customer 110 via the ecommerce gaming application 104, such that the ecommerce gaming application 104 communicates with the online sales system 102 and completes a purchase with application of the earned shopping discount.

In a related embodiment, an ecommerce gaming application 104 can comprise:
A processor 202;
A memory 204;
An input/output 206;
A game controller 210;
A Discount manager 212; and
A purchasing manager 214; all connected via
A data bus 320;
   wherein the game controller 210 can execute a game played by a customer 110, and the discount manager 212 can process and store associated shopping discounts, such that the customer 110 can complete a product purchase transaction via the purchasing manager 214.

In related embodiments, the ecommerce gaming application 104 can include configurations as:
A web application, executing in a Web browser;
A tablet app, executing on a tablet device, such as for example an Android or iOS tablet device;
A mobile app, executing on a mobile device, such as for example an Android phone or iPhone, or any wearable mobile device;
A desktop application, executing on a personal computer, or similar device;
An embedded application, executing on a processing device, for example a smart TV, a game console or other system.

In an embodiment, when a customer or customers 110 play(s) a game, a section of a game, a portion of a game, a level of a game, a combination of portions of game(s), a combination of different games or plays a game more than once and wins, the price(s) of the product(s) or service(s) can drop a set amount of currency or a certain percentage of discount can be reduced from the original price(s).

In related embodiments, the customer(s) 110 may play the game(s) first, then choose the product(s) or service(s) or alternatively choose the product(s) first and then play the game(s). In addition, the customer(s) 110 may do the playing, the choosing of the product(s) and the buying on different online sales systems 102 or do all actions on the ecommerce gaming application 104.

In a related embodiment, the customer or customers 110 can play a game or games on the ecommerce gaming application 104, and when the customer(s) 110 win(s), they can choose their product(s) or service(s), and receive a code online through the ecommerce gaming application 104 or via email, or other messaging, such that the customer 110 can present the code at the respective place of business, such as a shop or restaurant, and buy the product(s) or service(s) using the code which provides a discount on the product(s) or service(s).

In a related embodiment, a seller, such as a restaurant or a business, can put one single product or service for sale, such that customers or gamers 110 can compete to buy one single product or service, which can be a used or new product. The single product or service can be offered for a specified time frame of for example a few hours, a day, few days or weeks, so that customers or gamers 110 can play the same game(s) or different game(s) and whoever scores the highest, or whoever scores the highest with the best time, can win and thereby can be awarded a right to buy that product or service, such that the right can include a discount.

In a related embodiment, a game can be a quiz or other game related to a company or a company's products, such that successful game performance requires knowledge of the company or the company's products.

In a related embodiment, a game can be a quiz or other company related to a brand, such that successful game performance requires knowledge of the brand.

In a related embodiment, a game can have an educational focus related to a group of products for which discounts are offered.

In related embodiments, the game can be a trivia game or an entertainment game, such as Angry Birds and similar games that are common on mobile devices.

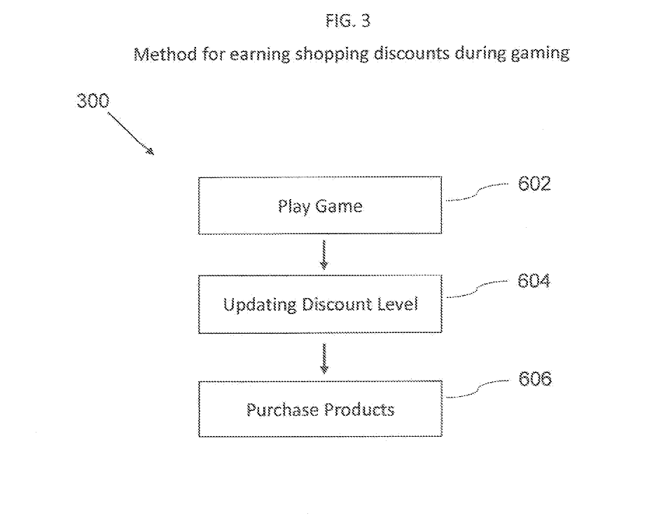

In an embodiment, illustrated in FIG. 3, a method for earning shopping discounts during gaming includes the steps of:
Playing a game 602;
Updating discount level 604; wherein discounts are earned and updated, depending on gameplay performance during the act of playing a game 602;
Purchasing products 606; wherein products are purchased at a price which equals an original price, less earned discounts.

FIGS. 1, 2, and 3 are block diagrams and flowcharts methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

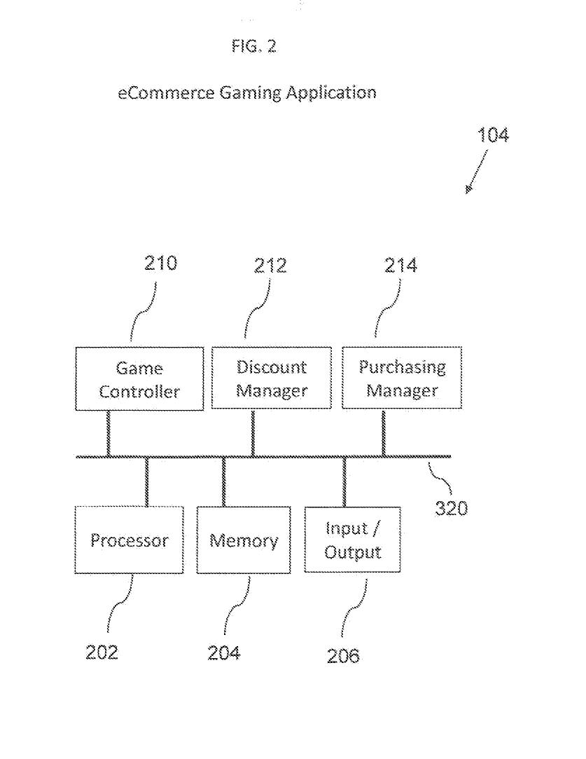

In this regard, FIGS. 1 and 2 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

It shall be understood that the above-mentioned components of the online sales system 102 and the ecommerce gaming application 104 are to be interpreted in the most general manner. For example, the processor 202 can include a single physical microprocessor or microcontroller, a cluster of processors, a datacenter or a cluster of datacenters, a computing cloud service, and the like.

In a further example, the memory 204 can include various forms of non-transitory storage media, including random access memory and other forms of dynamic storage, and hard disks, hard disk clusters, cloud storage services, and other forms of long-term storage. Similarly, the input/output 206 can include a plurality of well-known input/output devices, such as screens, keyboards, pointing devices, motion trackers, communication ports, and so forth.

Furthermore, it shall be understood that the online sales system 102 and the ecommerce gaming application 104 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system. An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the online sales system 102 communicates with the ecommerce gaming application 104 over a network, which can include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit and scope of the invention. For example, alternative embodiments can reconfigure or recombine the components of the online sales system 102 and the ecommerce gaming application 104, such that for example all functions and component of the online sales system 102 are contained as part of the ecommerce gaming application 104.

Furthermore, the present invention includes the following: the fact of playing a game (it can be a section, a part of a game) or games (they can be multiple sections or parts of a game or games) and by winning the game or games the player will drop the price of an existing product or service (there can be also be more than one product or service) or win a discount on a future purchase.

Many such alternative configurations are readily apparent, and should be considered to be fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

The invention being thus described, it will be evident that the same may be varied in many ways. Such variations are not to be regarded as a departure from the spirit and scope of the invention and all such modifications are intended to be included within the scope of the claims.

What is claimed is:

1. A system for ecommerce and gaming for use by a customer, comprising:
an online sales system; and
an ecommerce gaming application;
wherein the customer can play a game on the ecommerce gaming application and thereby earn shopping discounts, such that the customer can complete a product purchase transaction on the online sales system.

2. A system as claimed in claim 1, wherein the product purchase transaction can be executed by the customer in direct communication with the online sales system, for example using a discount code issued by the ecommerce gaming application or by use of a single-sign-on user id, wherein the discount level can be looked up by the online sales system in communication with the ecommerce gaming application.

3. A system as claimed in claim 1, wherein said ecommerce gaming application comprises:
a processor;
a memory;
an input/output;
a game controller;
a discount manager; and
a purchasing manager; all connected via a data bus;
wherein said game controller can execute a game played by the customer, and the discount manager can process and store associated shopping discounts, such that the customer can complete a product purchase transaction via said purchasing manager.

4. A system as claimed in claim 1, wherein the customer can play a game or games on the ecommerce gaming application, and when the customer 110 wins, the customer can choose a product or service, and receive a code online through any of the ecommerce gaming application, via email, and via other messaging types, such that the customer can present the code at the respective place of business, and buy the product or service using the code which provides a discount on the product or service.

5. A system as claimed in claim 1, wherein a seller, such as a restaurant or a business, can put one single product or service for sale, such that customers or gamers can compete to buy one single product or service, which can be a used or new product.

6. A system as claimed in claim 1, wherein the single product or service can be offered for a specified time frame of so that customers or gamers can play the same game or different game and whichever among the customers scores the highest can win and thereby be awarded a right to buy that product or service, such that the right includes a discount.

7. A method for earning shopping discounts during gaming, comprising the steps of:
providing an online sales system;
providing an ecommerce gaming application;
said ecommerce gaming application being used by a customer for playing a game;
said ecommerce gaming application updating a discount level, wherein discounts are earned and updated depending on gameplay performance during the act of playing a game;
enabling the user to use one of said ecommerce gaming application and said online sales system for purchasing products, wherein products are purchased at a price which equals an original price less earned discounts.

8. A pricing discount system, comprising:
a game which can be played by a player; the game having sections; and
a discounting means;
wherein the act of playing a game, a section of a game, or a part of a game or games, has a result; and wherein if the result qualifies as a WIN by the player, the discounting means will do any one of: (a) drop the price of an existing product or service, (b) drop the price of more than one product or service, and (c) provide a discount on a future purchase.
